(19) United States
(12) Patent Application Publication
(10) Pub. No.: US 2004/0021895 A1
(43) Pub. Date: Feb. 5, 2004

(54) Systems and methods for reviewing printed hardcopy

(76) Inventors: Daniel Travis Lay, Meridian, ID (US); Curtis Reese, Boise, ID (US); Will Bradburn, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/210,336

(22) Filed: Aug. 1, 2002

(51) Int. Cl. B41F 1/00; G06K 1/00; G06F 15/00; H04N 1/00

(52) U.S. Cl. 358/1.15; 358/402

(57) ABSTRACT

Systems for providing an operator with the ability to review information corresponding to printed hardcopy are provided. One such system includes a printing device that is operative to receive print information via a communication network. The printing device prints hardcopy corresponding to the print information and acquires image data corresponding to the hardcopy printed. Additionally, the printing device provides access to information corresponding to the image data. Methods, computer-readable media and other systems also are provided.

### BACKGROUND OF THE INVENTION

1. Field of the Invention

The present invention generally relates to printing and, in particular, to systems and methods that provide an operator with the ability to review information corresponding to printed hardcopy.

2. Description of the Related Art

Communication networks enable various functions to occur in a hardware-distributed environment. For instance, a communication network can enable an operator at a computer workstation to send print information to a remote printing device so that hardcopy can be produced by the printing device. As is known, attempting to ensure that the printed hardcopy will be printed in an acceptable format before printing occurs can save time in such an environment. This is because time may not be wasted discovering that printing was unacceptably accomplished, and then taking time to print the hardcopy again.

In an attempt to ensure that printed hardcopy will be produced in an acceptable format, various applications offer a “print preview” function. Such a function enables an operator to view a graphical approximation of the hardcopy that is to be produced by a printing device. This is accomplished by using a printer driver to interpret print information and then displaying the interpreted information to the operator via a display device. Although the interpreted information displayed to the operator typically closely corresponds to hardcopy that will be printed using the print information, the interpreted information clearly is only an approximation of how the hardcopy will appear. Therefore, performing a “print preview” function and checking the accuracy of the interpreted information does not entirely ensure that the hardcopy will be properly produced by the printing device. This is because various malfunctions, for example, can occur at the printing device.

By way of example, if print information sent to a printing device corresponds to ten pages of hardcopy, and the printing device jams during the printing of page 6, the operator may not become aware that printing was improperly completed until arriving at the printing device to retrieve the hardcopy. Clearly, the use of “print preview” functionality cannot alleviate this problem.

Based on the foregoing, there is a need for improved systems and methods that address these and/or other perceived shortcomings of the prior art.

### SUMMARY OF THE INVENTION

The present invention involves providing an operator with the ability to review information corresponding to printed hardcopy. In this regard, an embodiment of a system of the invention includes a printing device that is operative to receive print information via a communication network. The printing device also prints hardcopy corresponding to the print information and acquires image data corresponding to the hardcopy printed. Additionally, the printing device provides access to information corresponding to the image data.

Another embodiment of a system of the invention includes a communication interface, a print mechanism and an image-capturing device. The communication interface is operative to receive print information via a communication network. The print mechanism is operatively coupled to the communication interface so that print information can be received and then printed to hardcopy. The image-capturing device is operatively coupled to the print mechanism and acquires image data corresponding to the hardcopy printed. The image-capturing device also is operatively coupled to the communication interface so that information corresponding to the image data can be provided to the communication network.

Another embodiment of a system of the invention includes an image data access system that is operative to receive information corresponding to acquired image data via a communication network. The image data access system converts the information to a browser-enabled format and provides access to the information at a first resolution via the communication network. In response to receiving a request for access to the information at a higher resolution, the image data access system also can provide access to the information at a higher resolution via the communication network.

Methods for enabling review of hardcopy also are provided. In this regard, one such method includes: enabling an operator to request printing of print information to hardcopy via a communication network; and enabling the operator to review image data acquired from the hardcopy via the communication network.

Another embodiment of a method in accordance with the invention includes: receiving a request for printing of print information to hardcopy via a communication network; acquiring image data corresponding to the hardcopy printed; and enabling an operator to review information corresponding to the image data via the communication network.

Still another embodiment of a method in accordance with the invention includes: providing print information to a printing device via a communication network such that the printing device is enabled to print the print information to hardcopy; receiving first information corresponding to image data acquired from the hardcopy printed; enabling an operator to review the first information; and enabling the operator to access second information corresponding to the image data acquired from the hardcopy printed, the second information exhibiting a higher resolution than the first information.

Computer-readable media storing computer programs for enabling printed hardcopy to be reviewed are provided as well. In this regard, one such computer-readable medium includes logic configured to receive a request for printing of print information to hardcopy via a communication network, logic configured to acquire image data corresponding to the hardcopy printed, and logic configured to enable an operator to review information corresponding to the image data via the communication network.

Another embodiment of a computer-readable medium includes logic configured to receive information corresponding to acquired image data via a communication network, logic configured to convert the information to a browser-enabled format, and logic configured to provide access to the information at a first resolution via the communication network. Logic configured to receive a request for access to the information at a higher resolution via the communication network, and logic configured to provide access to the information at the higher resolution via the communication network also are included.

### BRIEF DESCRIPTION OF THE SEVERAL VIEWS OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram depicting an embodiment of a print system in accordance with the present invention.

FIG. 2 is a flowchart depicting functionality of the embodiment of FIG. 1.

FIG. 3 is a schematic diagram depicting a computer or processor-based system that can be used to implement the hardcopy review system of FIG. 1.

FIG. 4 is a flowchart depicting functionality of the embodiment of the hardcopy review system of FIG. 3.

FIG. 5 is a flowchart depicting functionality of an embodiment of a printing device in accordance with the present invention.

FIG. 6 is a schematic diagram depicting a representative portion of an embodiment of a printing device with an associated image-capturing device in accordance with the present invention.

FIG. 7 is a schematic diagram depicting a representative portion of another embodiment of a printing device with an associated image-capturing device in accordance with the present invention.

FIG. 8 is a schematic diagram depicting a representative computing device showing a first methodology for enabling an operator to review printed hardcopy in accordance with the present invention.

FIG. 9 is a schematic diagram depicting information associated with an intended print job and review information provided by an embodiment of the hardcopy review system.

FIG. 10 is a schematic diagram depicting another embodiment of a print system in accordance with the present invention.

FIG. 11 is a flowchart depicting functionality of the embodiment of the image data access system of FIG. 10.

### DETAILED DESCRIPTION

As will be described in greater detail here, systems and methods in accordance with the present invention enable review of printed hardcopy. In particular, the invention involves capturing image data associated with printed hardcopy and then enabling review of information associated with the acquired image data. Thus, an operator that intended for a printing device to produce hardcopy can review the information associated with the acquired image data and determine, for example, whether printing was completed without having to travel to the printing device to make such a determination.

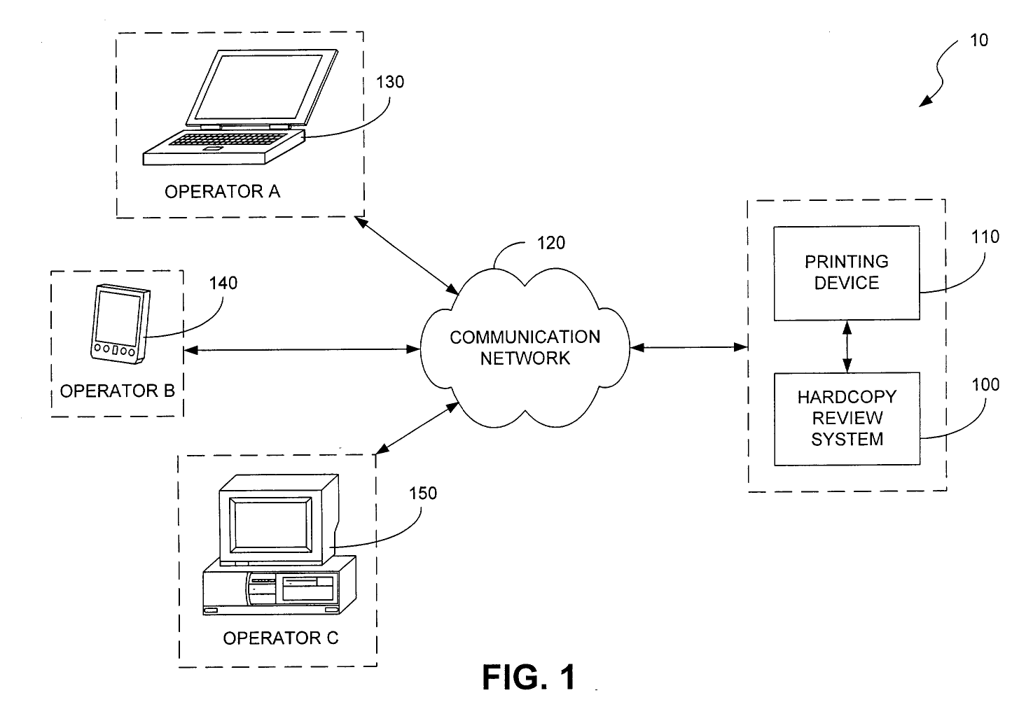

Referring now to the drawings, FIG. 1 is a schematic diagram depicting an embodiment of a print system in accordance with the present invention. As shown in FIG. 1, print system 10 includes a hardcopy review system 100 that communicates with a printing device 110. As used herein, the term “printing device” refers to any device or combination of devices that are able to produce printed hardcopy. Thus, the term “printing device” includes printers, facsimile machines, copiers and multifunction devices, among others.

The printing device 110 and/or hardcopy review system 100 communicate with a communication network 120. Communication network 120 enables communication of the printing device and/or hardcopy review system with various computing devices. As used herein, the term “computing device” refers to any device or combination of devices that are able to send, store and/or receive information via a communication network.

Note, communication network 120 may be any type of communication network employing any network topology, transmission medium, or network protocol. For example, such a network may be any public or private packet-switched or other data network, including the Internet, circuit-switched networks, such as the public switched telephone network (PSTN), wireless network, or any other desired communications infrastructure and/or combination of infrastructures.

Several exemplary computing devices are depicted in FIG. 1. By way of example, a laptop 130 (associated with operator A), a personal digital assistant (PDA) 140 (associated with operator B), and a workstation 150 (associated with an operator C) each can communicate with printing device 110 and/or hardcopy review system 100 via communication network 120.

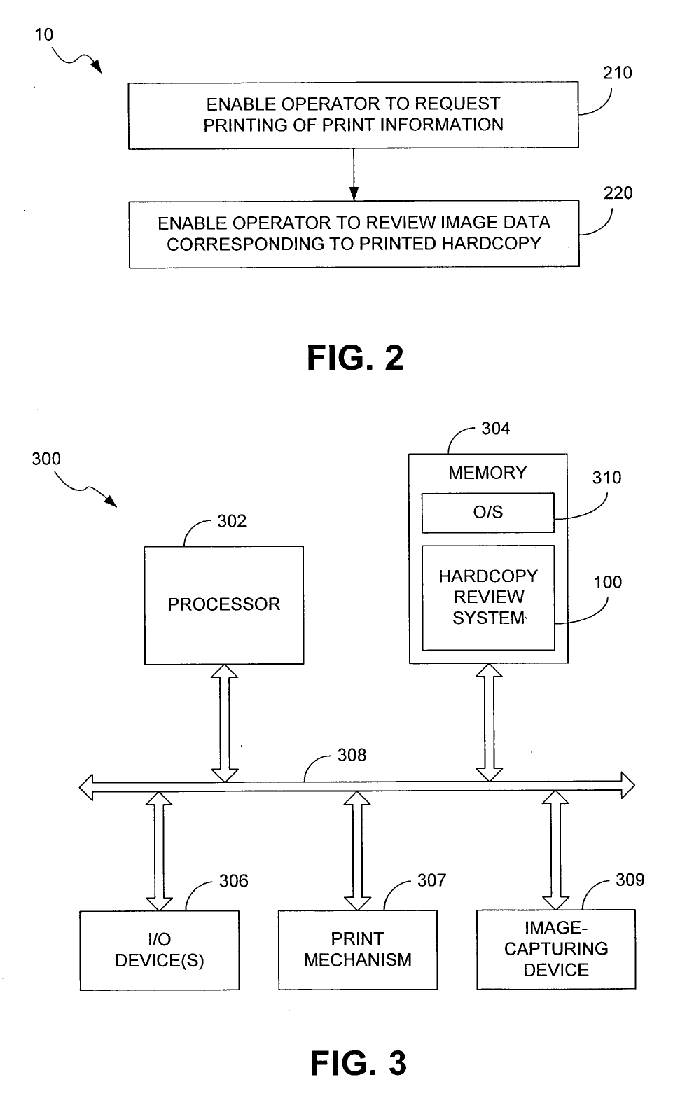

Functionality of print system 10 of FIG. 1 is depicted in the flowchart of FIG. 2. As shown in FIG. 2, the functionality (or method) 10 may be construed as beginning at block 210, where an operator is enabled to request printing of print information. Typically, this is accomplished by the operator providing a printing device with print information via a communication network. For instance, operator A (FIG. 1) can transmit print information to printing device 110 via communication network 120 by using laptop 130.

In block 220, the operator is enabled to review image data corresponding to hardcopy that was printed using the print information. More specifically, the operator can be provided with access to the image data so that a determination can be made as to whether printing was completed. In this manner, if it is determined that printing has not been completed, the operator can attempt to determine the cause and/or attempt to correct the problem.

Hardcopy review systems 100 in accordance with the invention can be implemented in software, firmware, hardware, or a combination thereof. When implemented in hardware, hardcopy review system 100 can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

When implemented in software, hardcopy review system 100 can be a program that is executable by a digital computer, an example of which is depicted schematically in FIG. 3. Note, computer 300 of FIG. 3 is particularly configured as a printing device, although various other embodiments could merely be adapted to communicate with printing devices.

In FIG. 3, computer 300 includes a processor 302, memory 304, and one or more input and/or output (I/O) devices 306 (or peripherals) that are communicatively coupled via a local interface 308. Processor 302 can be a hardware device configured to execute software that can be stored in memory 304. Memory 304 can include any combination of volatile memory elements and/or nonvolatile memory elements. Moreover, memory 304 can incorporate electronic, magnetic, optical, and/or other types of storage media. Note that memory 304 can have a distributed architecture, where various components are situated remote from one another, but can be accessed by processor 302.

The software in memory 304 can include one or more separate programs, each of which comprises an ordered listing of executable instructions for implementing logical functions. The software in the memory 304 includes hardcopy review system 100 and a suitable operating system (O/S) 310. The operating system 310 controls the execution of other computer programs, such as hardcopy review system 100.

The I/O device(s) 306 can include input devices such as a keypad and/or a clock, for example. I/O device(s) 306 also can include output devices such as a display device or speaker, for example. I/O device(s) 306 may further include devices that are configured to communicate both inputs and outputs such as a communication interface. Additionally, computer 300 includes a print mechanism 307, which transfers print information to hardcopy, and an image-capturing device 309, which acquires image data corresponding to the printed hardcopy.

When hardcopy review system 100 is implemented in software, it should be noted that the hardcopy review system 100 can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Hardcopy review system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

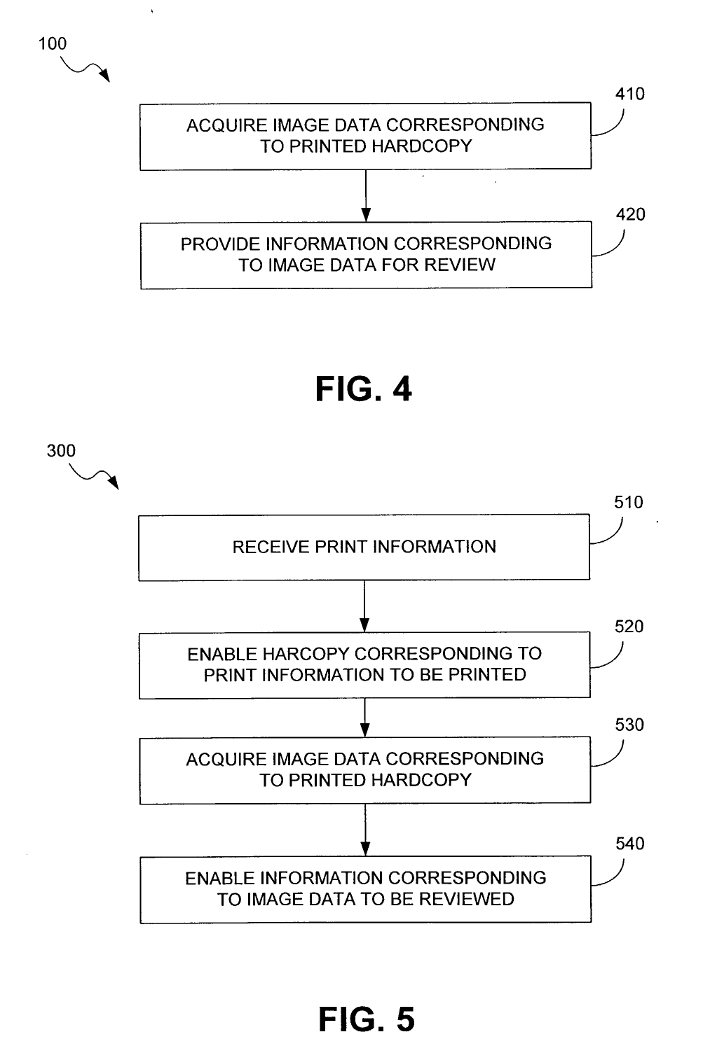

Reference will now be made to the flowchart of FIG. 4, which depicts the functionality of an embodiment of hardcopy review system 100 of the invention. In this regard, each block of the flowchart represents a module segment or portion of code that comprises one or more executable instructions for implementing the specified logical function(s). It should also be noted that in some alternative implementations the functions noted in various blocks of FIG. 4, or any other of the accompanying flowcharts, may occur out of the order in which they are depicted. For example, two blocks shown in succession in FIG. 4 may, in fact, be executed substantially concurrently. In other embodiments, the blocks may sometimes be executed in the reverse order depending upon the functionality involved.

As shown in FIG. 4, the functionality (or method) 100 may be construed as beginning at block 410, where image data corresponding to printed hardcopy is acquired. In block 420, information corresponding to the image data is provided for review. As mentioned before, the information can be provided for review to the operator requesting the printing, for example.

Functionality of the computer 300 of FIG. 3, which includes an embodiment of the hardcopy review system will now be described with reference to the flowchart of FIG. 5. As shown in FIG. 5, the functionality (or method) 300 may be construed as beginning at block 510, where print information is received. For instance, the print information can be received from a communication network via communication interface 306. In block 520, hardcopy corresponding to the print information is enabled to be printed. This typically involves converting the print information into bit map data and transferring the data to hardcopy using print mechanism 307. In block 530, image data corresponding to the printed hardcopy is acquired, such as by using image-capturing device 309. Thereafter, such as depicted in block 540, information corresponding to the image data is enabled to be reviewed.

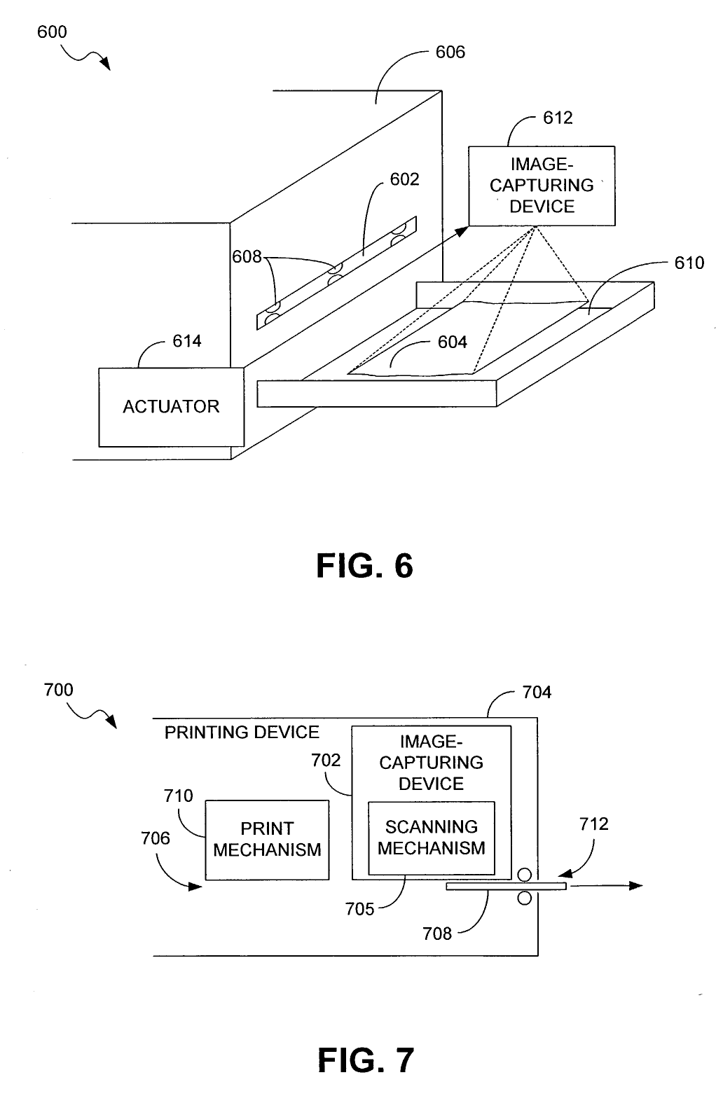

An embodiment of a printing device 600 that is associated with a hardcopy review system 100 is depicted schematically in FIG. 6. As shown in FIG. 6, printing device 600 includes a hardcopy output 602, which generally is configured as a slot. Hardcopy, such as document 604, is passed through the hardcopy output 602 after being produced by a print mechanism (not shown) that is internal to print box 606. In the embodiment of FIG. 6, rollers 608 are used to transport hardcopy 604 from the print box, through the hardcopy output 602, and into a hardcopy-receiving tray 610.

An image-capturing device 612 is oriented so that image data corresponding to printed hardcopy 604 can be acquired. Note, since the embodiment of the printing device of FIG. 6 provides printed hardcopy 604 in a face-up orientation within the tray, image-capturing device 612 is arranged above the tray.

An actuator 614 communicates with the image-capturing device 612 and provides a control input so that image data corresponding to the printed hardcopy 604 can be acquired. In particular, the actuator 614 determines when a page of hardcopy 604 has been delivered into the tray 610 and then notifies the image-capturing device 612 to acquire image data. Clearly, various types of actuators 614 can be used to facilitate the aforementioned functionality. By way of example, various tray-sensing techniques can be used, such as sensing the weight of the tray 610 for determining that another page of hardcopy 602 has been provided to the tray 610. As another example, roller travel can be sensed. This is because rotational displacement of a roller, e.g., roller 608, which is used to direct hardcopy 602 through a print device, corresponds to linear displacement of hardcopy 602 traveling through the printing device 600. Therefore, when the size of the print medium, e.g., paper, is known, tracking roller 608 rotation enables image acquisition for each page of hardcopy 602 to be properly timed.

Another embodiment of a printing device 700 that is associated with a hardcopy review system 100 is depicted schematically in FIG. 7. As shown in FIG. 7, an image-capturing device 702 is mounted within the print box 704. In this embodiment, the image-capturing device includes a scanning mechanism 705 that is arranged along the print-processing path 706 of the printing device 700. The scanning mechanism sequentially acquires lines of image data from a page 708 of hardcopy as the page travels along the print-processing path 706. Thus, as printed hardcopy is produced by print mechanism 710 and is directed toward the hardcopy output 712, the image-capturing device 702 scans image data from each page of hardcopy before the hardcopy is output from the print box 704.

Once image data corresponding to printed hardcopy is acquired, the information can be stored and/or converted to various formats. For instance, the image data can be converted to a browser-useable format, e.g., .jpeg or .gif. In some embodiments, the type of format used can be based on the type of computing device that the operator used to request printing. By way of example, if the operator requested printing of hardcopy from a workstation, it could be assumed that the workstation supports file formats, such as, .pdf, that may not be compatible with small form-factor devices, such as PDAs. Clearly, other types of formats could be used and will not be described here.

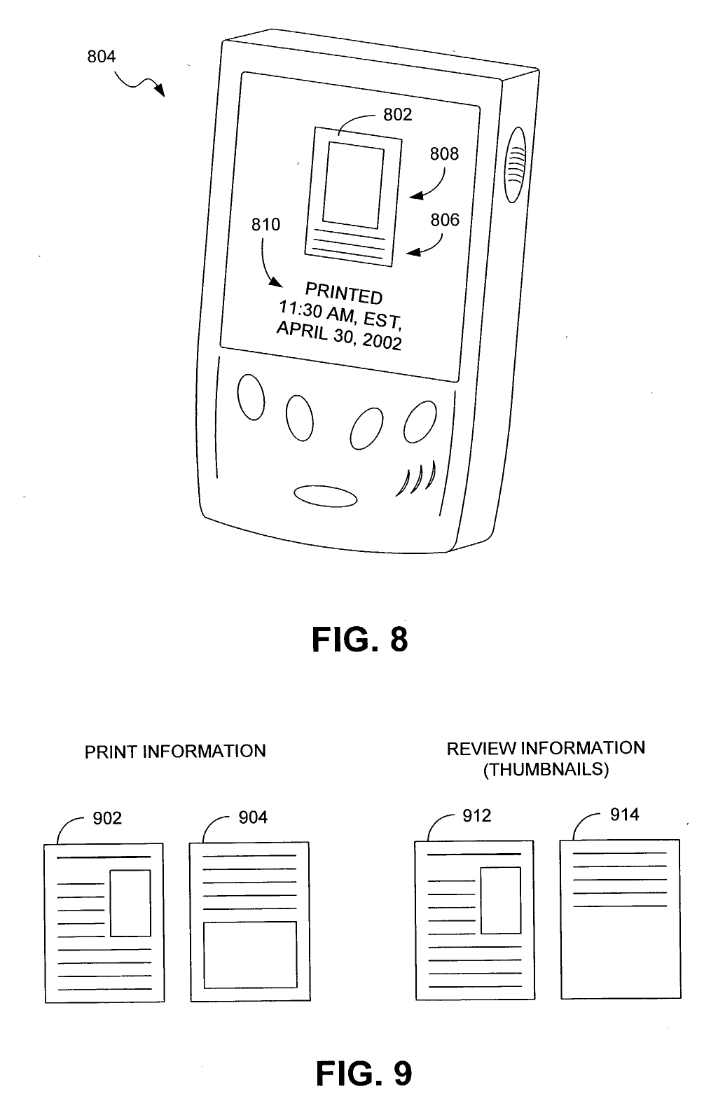

Various information corresponding to the image data can be made accessible for review. By way of example, information corresponding to the image data can be provided directly to the operator that requested printing. As shown in FIG. 8, the information can be provided in a graphical form representative of the printed hardcopy. The information can be viewed by the operator, such as via a display of a computing device.

In the embodiment of FIG. 8, the information is provided as a thumbnail that does not include all of the detail present in the printed hardcopy. However, enough detail is provided to the operator so that a gross determination can be made as to whether the print job was completed. As shown in FIG. 8, the thumbnail 802 of a page of hardcopy is displayed on a computing device 804. Thumbnail 802 includes indicia of text 806 and indicia of pictorial information 808 that is exhibited by the corresponding hardcopy. Note, depending upon the computing device, e.g., the form factor of the device, the information made accessible to an operator can be customized to include more or less detail. For instance, when information is accessed by a PDA, the information may include less detail compared to when the information is accessed by a workstation. Clearly, when a large form-factor device such as a workstation is used, the image data could be provided to the device at the resolution at which it was acquired.

Even if the computing device used by an operator can support full resolution image data, embodiments of the hardcopy review system may still initially provide a user with access to thumbnails corresponding to the acquired image data. Optionally, such an operator could request access to higher resolution image data, such as by selecting one or more thumbnails of interest. In response to selecting a thumbnail, such as by double-clicking, the higher resolution information could be provided. Clearly, the higher resolution information could be provided as a full page of image data if the computing device of the operator could display an entire page. If, however, the computing device can not support display of an entire page, such a computing device could benefit from the image data being provided in a Wireless Application Protocol (WAP)-enabled format, for example. This can enable the operator to view an entire page of image data, one portion at a time, by scrolling the page of image data on the display of the computing device. Note, the higher resolution information could be provided via a Web page, as will be described later.

In some embodiments, the information corresponding to the acquired image data can include time-coding information, e.g., information 810 of FIG. 8. More specifically, information corresponding to the date and/or time that hardcopy was printed can be acquired and then associated with the image data. Thus, during review of information corresponding to the printed hardcopy, an operator can be provided with an indication of when the hardcopy was actually printed. Note, this can be a form of virtual time-coding, in that the hardcopy produced by the printing device may not actually exhibit time-coding information.

Typically, time-coding is facilitated by a clock that is associated with the image-capturing device used to acquire the image data. Time-coding information provided by the clock is associated with the image data, such as by storing the time-coding data in a tagged file or inserting the time-coding data into the image data stream produced by the image-capturing device, for example. Regardless of the particular technique used, the time-coding data can be provided to the operator such as depicted in FIG. 8, for example. As another example, the time-coding information could be provided to the user as a subject line of an email that indicates that the printing is completed.

FIG. 9 is a schematic diagram that depicts two pages (902 and 904) of a representative print job, which corresponds to print information that an operator intends to have printed. Assuming that page 904 of the intended print job is not properly printed by a printing device, embodiments of the hardcopy review system can provide review information to the operator that clearly indicates that printing was not properly completed. Note, in FIG. 9, the review information provided to the operator does not correspond directly to the intended print job, i.e., the second thumbnail (page 914 of the review information) does not match page 904. This should alert the operator that an error in printing may have occurred.

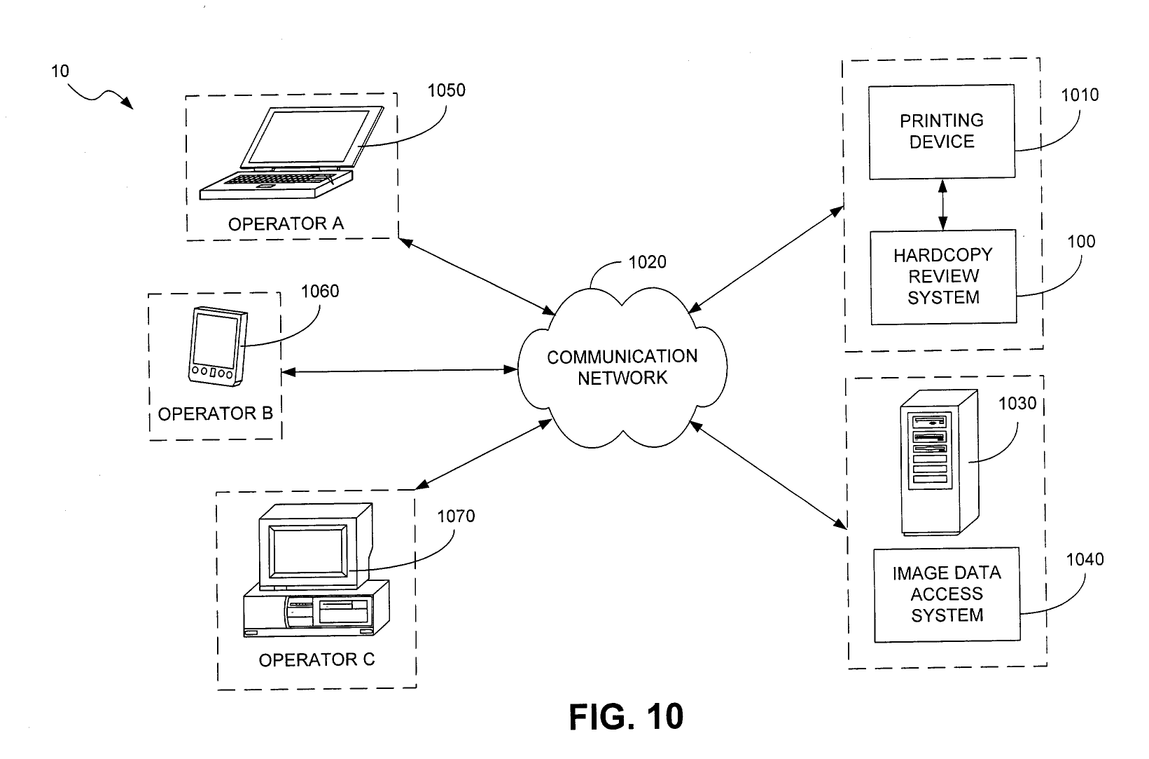

As mentioned before, information corresponding to acquired image data can be stored and/or provided to an operator in various manners. In this regard, an embodiment of a print system in accordance with the invention that stores and provides information via the Internet will now be described with reference to FIG. 10.

In FIG. 10, print system 10 includes a hardcopy review system 100 that communicates with a printing device 1010. The printing device 1010 and/or hardcopy review system 100 communicate with a communication network 1020. A web server 1030 and an associated image data access system 1040 communicate with the printing device 1010 and/or hardcopy review system 100 via the communication network 1020. Several exemplary computing devices, e.g., laptop 1050, PDA 1060, and workstation 1070, also communicate with the communication network 1020.

In operation, an operator enables print information to be provided to printing device 1010 so that the printing device 1010 can produce hardcopy. In response, the hardcopy review system 100 acquires image data corresponding to the hardcopy. The image data access system 1040 is then used to provide the user with access to information 1070 corresponding to the image data.

By way of example, once image data has been acquired, the hardcopy review system 100 enables information corresponding to the image data to be sent to the image data access system 1040. The information then can be stored, such as at the web server (1030) associated with the image data access system 1040. In some embodiments, the information can be converted to a browser-enabled format by the hardcopy review system prior to transmission. Alternatively, conversion of the image data, if required, can be accomplished by the image data access system 1040.

In some embodiments, the operator is provided with an address, e.g., a URL, at which the information is posted for review. Clearly, the address could be provided to the operator via the hardcopy review system 100 or by the image data access system 1040. If provided by the image data access system 1040, the hardcopy review system 100 provides information for contacting the operator to the image data access system 1040 so that contact with the operator can be facilitated.

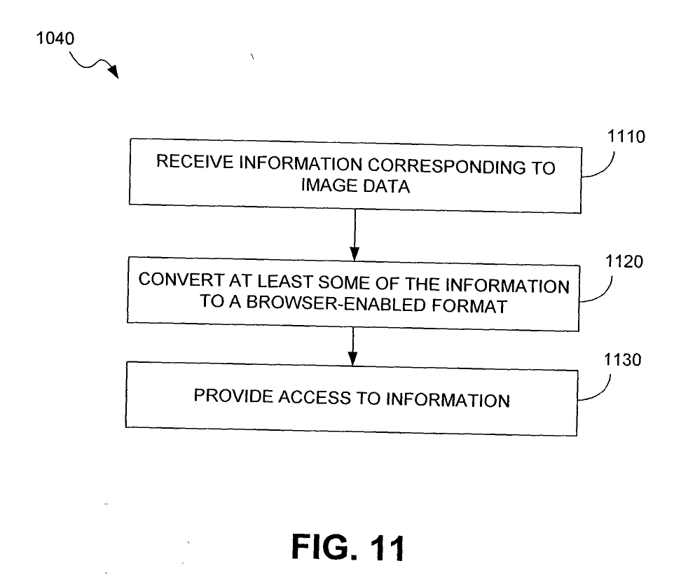

Functionality associated with the embodiment of the image data access system 1040 of FIG. 10 will now be described using the flowchart of FIG. 11. As shown in FIG. 11, the functionality (or method) 1040 may be construed as beginning at block 1110, where information corresponding to image data acquired from printed hardcopy is received. In block 1120, at least some of the information is converted to a browser-enabled format, if necessary. In block 1130, access to the information is provided to the operator, such as by posting the information to a Web site.

The foregoing description has been presented for purposes of illustration and description. It is not intended to be exhaustive or to limit the invention to the precise forms disclosed. Modifications and/or variations are possible in light of the above teachings. The embodiments discussed, however, were chosen and described to provide an illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A method for enabling printed hardcopy to be reviewed, said method comprising:
receiving a request for printing of print information to hardcopy via a communication network;
acquiring image data corresponding to the hardcopy printed; and
enabling an operator to review information corresponding to the image data via the communication network.

2. The method of claim 1, wherein enabling the operator to review the information comprises:
posting the information to a Web site; and
providing the operator with access to the Web site.

3. The method of claim 1, wherein enabling the operator to review the information comprises:
creating at least one thumbnail graphical representation corresponding to the hardcopy printed; and
providing information corresponding to the thumbnail to the operator.

4. The method of claim 1, wherein the information corresponding to the image data includes an indication of a time that the hardcopy was printed.

5. The method of claim 1, further comprising:
providing the operator with an indication that printing of the print information to hardcopy has been completed.

6. A method for enabling hardcopy printed by a printing device to be reviewed via a communication network, said method comprising:
enabling an operator to request printing of print information to hardcopy via a communication network; and
enabling the operator to review image data corresponding to the hardcopy via the communication network.

7. The method of claim 6, wherein the printing device includes an image-capturing device; and
wherein the image data is acquired by the image-capturing device.

8. The method of claim 6, wherein enabling the operator to review the image data comprises:
converting the image data to a format viewable by the operator.

9. The method of claim 8, wherein the request for printing the print information is provided to the printing device via a computing device; and
wherein converting the image data comprises:
determining a type format supported by the computing device; and
converting the image data to the type of format determined.

10. A method for reviewing hardcopy printed by a printing device, said method comprising:
enabling print information to be provided to a printing device via a communication network such that the printing device is enabled to print the print information to hardcopy;
receiving first information corresponding to image data acquired from the hardcopy printed;
enabling an operator to review the first information; and
enabling the operator to access second information corresponding to the image data acquired from the hardcopy printed, the second information exhibiting a higher resolution than the first information.

11. The method of claim 10, wherein the first information includes a thumbnail graphical representation corresponding to each page of the printed hardcopy.

12. The method of claim 10, wherein enabling the operator to access the second information comprises:
enabling the operator to select a particular page of the printed hardcopy; and
providing the operator with second information corresponding to the page selected.

13. A system for enabling printed hardcopy to be reviewed by an operator via a communication network, said system comprising:
a printing device operative to receive print information via a communication network, print hardcopy corresponding to the print information, acquire image data corresponding to the hardcopy printed, and provide access to information corresponding to the image data.

14. The system of claim 13, further comprising:
means for indicating a time that the hardcopy was printed.

15. A system for enabling printed hardcopy to be reviewed by an operator via a communication network, said system comprising:
a communication interface operative to receive print information via a communication network;
a print mechanism operatively coupled to the communication interface such that the print mechanism receives print information, the print mechanism being operative to print the print information to hardcopy; and
an image-capturing device operatively coupled to the print mechanism and being operative to acquire image data corresponding to the hardcopy printed, the image-capturing device also being operatively coupled to the communication interface such that information corresponding to the image data can be provided to the communication network.

16. The system of claim 15, wherein the printing device includes a print box and the print mechanism is located within the print box; and
wherein the image-capturing device is located outside the print box.

17. The system of claim 16, further comprising:
a hardcopy-receiving tray extending from the print box; and
an actuator operatively coupled to the hardcopy-receiving tray and adapted to determine when a page of hardcopy is received by the hardcopy-receiving tray such that the actuator provides a control input to the image-capturing device for initiating acquisition of image data.

18. The system of claim 15, wherein the printing device includes a print box, the print mechanism is located within the print box, and the print box has a roller operative to direct hardcopy from within the print box to an exterior of the print box; and
further comprising:
an actuator operatively coupled to the roller and adapted to determine a rotational displacement of the roller such that, when a page of hardcopy is directed by the roller and output from the print box, the actuator provides a control input to the image-capturing device for initiating acquisition of image data.

19. The system of claim 15, wherein the printing device includes a print box and the print mechanism is located within the print box; and
wherein the image-capturing device is located inside the print box.

20. The system of claim 19, wherein the image-capturing device is a scanning mechanism arranged along a print-processing path between the print mechanism and a hardcopy output of the print box.

21. The system of claim 15, further comprising:
a clock operatively coupled to the image-capturing device such that information corresponding to a time hardcopy was printed can be associated with image data corresponding to the hardcopy.

22. A system for enabling printed hardcopy to be reviewed by an operator via a communication network, said system comprising:
an image data access system operative to receive information corresponding to acquired image data via a communication network, convert the information to a browser-enabled format, and provide access to the information at a first resolution via the communication network.

23. The system of claim 22, wherein the image data access system is further operative to receive a request for access to the information at a higher resolution via the communication network, and provide access to the information at a higher resolution via the communication network.

24. The system of claim 22, wherein the information of the first resolution is in the form of a thumbnail representative of the image data.

25. A computer-readable medium storing a computer program for enabling printed hardcopy to be reviewed by an operator via a communication network, said computer-readable medium comprising:
logic configured to receive information corresponding to acquired image data via a communication network;
logic configured to convert the information to a browser-enabled format;
logic configured to provide access to the information at a first resolution via the communication network;
logic configured to receive a request for access to the information at a higher resolution via the communication network; and
logic configured to provide access to the information at a higher resolution via the communication network.

26. The computer-readable medium of claim 25, wherein the logic configured to provide access to the information at a first resolution comprises:
logic configured to provide a thumbnail representative of the image data.

27. The computer-readable medium of claim 25, wherein the logic configured to provide access to the information at a higher resolution comprises:
logic configured to provide an operator with at least one of an IP address, a URL and a network machine name at which the information is posted at the higher resolution.

28. A computer-readable medium storing a computer program for enabling printed hardcopy to be reviewed by an operator via a communication network, said computer-readable medium comprising:
logic configured to receive a request for printing of print information to hardcopy via a communication network;
logic configured to acquire image data corresponding to the hardcopy printed; and
logic configured to enable an operator to review information corresponding to the image data via the communication network.

29. The computer-readable medium of claim 28, wherein the logic configured to enable the operator to review the information comprises:
logic configured to post the information to a Web site; and
logic configured to provide the operator with access to the Web site.

30. The computer-readable medium of claim 28, wherein the logic configured to enable the operator to review the information comprises:
logic configured to create at least one thumbnail corresponding to the hardcopy printed; and
logic configured to provide the thumbnail to the operator.

31. The computer-readable medium of claim 28, further comprising:
logic configured to indicate a time that the hardcopy was printed.

32. The computer-readable medium of claim 28, further comprising:
logic configured to provide the operator with an indication that printing of the print information to hardcopy has been completed.
